(19) United States
(12) Patent Application Publication
(10) Pub. No.: US 2012/0151819 A1
(43) Pub. Date: Jun. 21, 2012

(54) Speedy Tackle Box

(76) Inventor: Pedro Solis, La Joya, TX (US)

(21) Appl. No.: 12/794,562

(22) Filed: Jun. 4, 2010

(51) Int. Cl. A01K 97/06; A01K 97/00

(52) U.S. Cl. 43/54.1

(57) ABSTRACT

A tackle box for fishing supplies may include a top section, a bottom section being pivotably connected to the top section, and a removable tray being removable from the bottom section. The removable tray may include a tensioning device to tension a fishing line. The removable tray may include an upward extending rod to cooperate with the tensioning device, and the tensioning device may include a base and a threaded shaft which extends through an aperture of the base. The tensioning device may include a knob for turning the threaded shaft, and the tensioning device may include a finger connected to the threaded shaft. The finger may traverse to the axial direction of the threaded shaft, and the upward extending rod may include a radial groove. The top section may include a removable tray, and the removable tray may include a spool to dispense the fishing line, and the spool may rotate on a shaft.

### FIELD OF THE INVENTION

The present invention relates to tackle boxes and more particularly to a tackle box that includes a tensioning device.

### BACKGROUND

A fisherman uses a fishing pole which is connected to a fishing line which is extended from the fishing pole and which is connected to at least one fishing hook. When the fishing line and the fishing hook are extended, there is a tendency for the fishing hook to rotate which would rotate and twist the fishing line. A fishing swivel is used to allow the fishing hook to rotate and to prevent the fishing line from twisting. A fishing swivel is a small device consisting of two rings connected to a pivoting joint. The device is usually made of metal, and the pivoting joint is usually ball- or barrel-shaped. The line from a rod and reel is tied to one end, and a length of fishing line, often terminated by a hook, lure or sinker, is tied to the other. The main purpose of the swivel is to allow the line to untwist during line retrieval, preventing undesirable tangling. This is particularly important for users of monofilament test line. A secondary benefit of the fishing swivel is that it may stop a sliding sinker, which depending on fishing method may be placed before or after the swivel. Snap swivels have a safety-pin like clip linked to one of the rings. Lures may be affixed directly to the snap. Multiple swivels may be employed and interconnected with fishing line in order to support multiple hooks which ultimately are connected to a single fishing line that is controlled by the user. Transporting these fishing lines with multiple swivels present problems in that it is difficult to keep the fishing line from tangling during transportation.

### SUMMARY

A tackle box for fishing supplies may include a top section, a bottom section being pivotably connected to the top section, and a removable tray being removable from the bottom section. The removable tray may include a tensioning device to tension a fishing line.

The removable tray may include an upward extending rod to cooperate with the tensioning device, and the tensioning device may include a base and a threaded shaft which extends through an aperture of the base.

The tensioning device may include a knob for turning the threaded shaft, and the tensioning device may include a finger connected to the threaded shaft.

The finger may traverse to the axial direction of the threaded shaft, and the upward extending rod may include a radial groove.

The top section may include a removable tray, and the removable tray may include a spool to dispense the fishing line, and the spool may rotate on a shaft.

The removable tray may include a compartment defined by compartment walls to contain the spool, and the at least one compartment wall may include a slit to hold the fishing line.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front view the tackle box of the present invention in a closed position;

FIG. 2 illustrates a bottom view of the top section of the tackle box of the present invention;

FIG. 3 illustrates a back view of the bottom section of the tackle box of the present invention;

FIG. 4 illustrates a front view of the bottom section of the tackle box of the present invention;

FIG. 5 illustrates a side view of the bottom section of the tackle box of the present invention;

FIG. 6 illustrates a back view of the bottom section of the tackle box of the present invention;

FIG. 7 illustrates a top view of the organizer box of the tackle box of the present invention;

FIG. 8 illustrates a bottom view of the top section of the tackle box of the present invention;

FIG. 9 illustrates a side view of the tackle box of the present invention in an open position;

FIG. 10 illustrates another side view of the tackle box of the present invention in an open position;

FIG. 11 illustrates a side view of the tackle box of the present invention;

FIG. 12 illustrates another side view of the tackle box of the present invention;

FIG. 13 illustrates a top view of the tackle box of the present invention;

FIG. 14 illustrates a side view of the top section of the tackle box of the present invention;

FIG. 15 illustrates another side view of the top section of the tackle box of the present invention;

FIG. 16 illustrates a back view of the top section of the tackle box of the present invention;

FIG. 17 illustrates a front view of the top section of the tackle box of the present invention;

FIG. 18 illustrates a perspective view of the removable tray of the present invention;

FIG. 19 illustrates a side view of the removable tray of the present invention;

FIG. 20 illustrates another side view of the removable tray of the present invention;

FIG. 21 illustrates a back view of the removable tray of the present invention;

FIG. 22 illustrates a front view of the removable tray of the present invention;

FIG. 23 illustrates a top view of the removable tray of the present invention;

FIG. 24 illustrates a cross-sectional view of the tackle box of the present invention;

FIG. 25 illustrates a cross-sectional view of the top section of the present invention.

### DETAILED DESCRIPTION

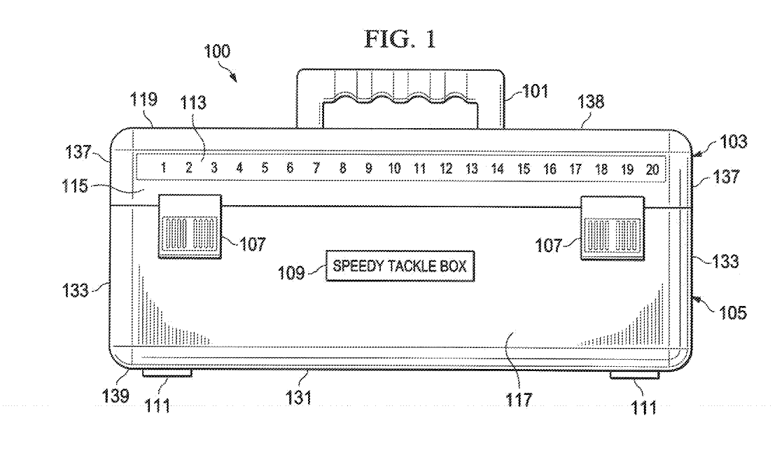

FIG. 1 illustrates a tackle box 100 which may include a top section 103 and a bottom section 105 and which may be substantially rectangular or other appropriate shape. The top section 103 may pivot with respect to the bottom section 105 in order for the user to access the interior of the tackle box 100. FIG. 1 illustrates that the top section 103 may include a front top section surface 115 and that the bottom section 105 may include a front bottom section surface 117. The top section 103 may include a top surface 119 which may have a handle 101 mounted, and the handle 101 may rotate approximately 180°. The front top section surface 115 may include a ruler indicia 113 which may include indicia to indicate inches or other appropriate measurements. The front top section surface 115 may have a fastening device 107 mounted on the front top section surface 115 in order to detachably connect to the bottom section 105. The front top section surface 115 when closed may be in substantially the same plane as the front bottom section surface 117 and the front bottom section surface 117 may include indicia 109 which may include a trademark of the tackle box 100. The front top section surface 115 may be adjacent to opposing side top section surfaces 137, and the bottom top section surface 117 may be adjacent to opposing side bottom section surfaces 113. The front top section surface 115 and the side top section surfaces 137 may be connected to the top surface 119, and the front bottom section surface 117 and the side bottom section surfaces 133 may be adjacent to the bottom surface 131 which may include feet 111 for the tackle box 100. The top surface 119 and the side top section surface 137 may be connected to the back top section surface 135 and the bottom surface 131 and the side bottom section surface 133 may be connected to the back bottom surface 139.

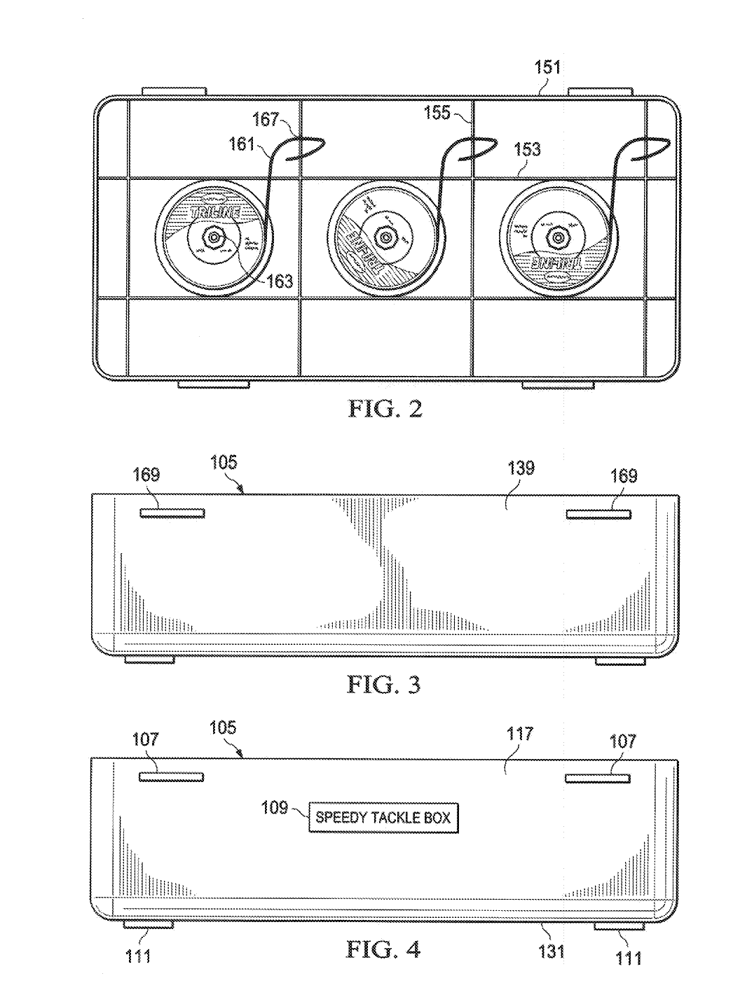

The top section 103 and the bottom section 105 may be hollow in order to cooperate with a removable tray 151, and FIG. 2 illustrates a bottom view of the removable tray 151 which may include various compartments 153 which may be defined by horizontal walls 153 and intersecting vertical walls 155. The compartments of the present invention may be square shaped, rectangular shaped, circular shaped, oval shaped or other appropriate shapes. The tray compartments 153 may be empty to accept fishing supplies or may include a spool 159 of fishing line 161. The spool 159 may be mounted on a shaft 163 which may be connected to the bottom surface opposed to the top surface 119 of the top section 103 and maybe held by a fastening device 165 such as a bolt, and the spool 159 may rotate on shaft 163 in order to dispense the fishing line 161; the walls 153 157 may include a slit 167 to hold an end of the fishing line 161 in order to prevent the fishing line 161 from becoming entangled.

FIG. 3 illustrates a back view of the bottom section 105 which may include hinges 169 for cooperation with the top section 103 (not shown). FIG. 3 additionally illustrates the feet 111 and the back bottom section surface 139.

FIG. 4 illustrates a front view of the bottom section 105 and illustrates a portion of the fastening device 107 to fasten to the top section 103. The front bottom section surface 117 may include indicia 109, and FIG. 4 illustrates feet 111 extending from the bottom surface 131.

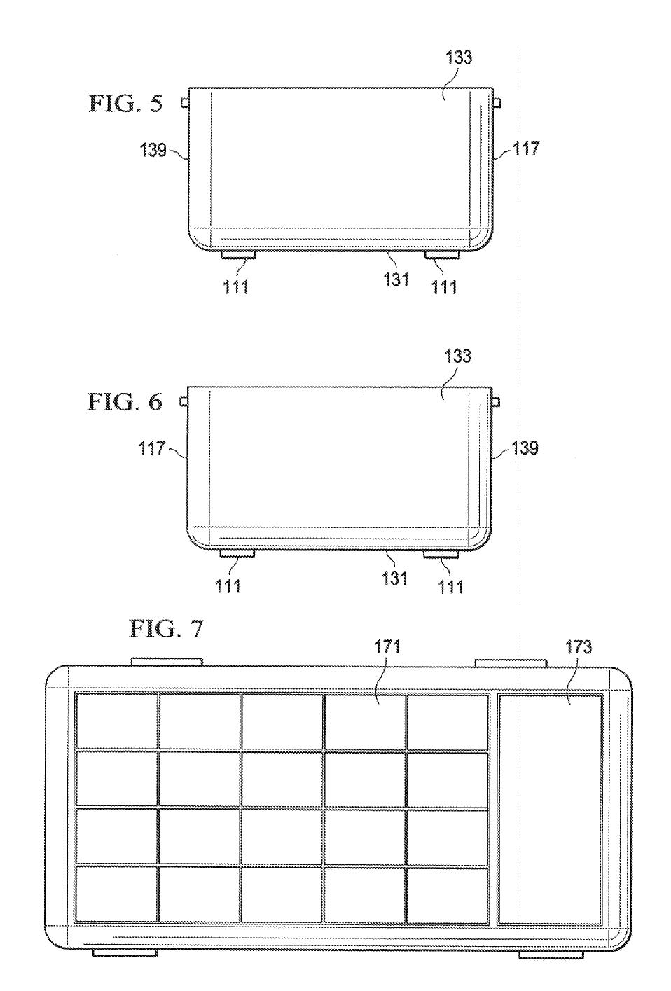

FIG. 5 illustrates a side view of the bottom section 105 and illustrates the side bottom section surface 133 and illustrates the feet 111 extending from the bottom surface 131. The side bottom section surface 133 is connected to the back bottom section surface 139 and the front bottom section surface 117.

FIG. 6 illustrates a side view of the bottom section 105 and illustrates the opposing side bottom section surface 133 and illustrates the feet 111 extending from the bottom surface 131. The side bottom section surface 133 is connected to the back bottom section surface 139 and the front bottom section surface 117.

FIG. 7 illustrates an organizer box 171 which may include various compartments for fishing related objects such as hooks and includes a larger compartment 173 for a toolbox.

FIG. 8 illustrates a bottom view of the bottom surface of the lid 151 which may include three compartments 153 which may be defined by horizontal walls 153 and intersecting vertical walls 155 which may provide support how to support the lid. The tray compartments 153 may be empty to accept fishing supplies or may include a spool 159 of fishing line 161. The spool 159 may be mounted on a shaft 163 which may be connected to the bottom surface of the top section 103 and maybe held by a fastening device 165 such as a bolt, and the spool 159 may rotate on shaft 163 in order to dispense the fishing line 161 the walls 153 157 may include a slit 167 to hold an end of the fishing line 161 in order to prevent the fishing line 161 from becoming entangled. Alternatively, the shaft 163 may be formed from a stud which may be molded into the lid at manufacturing.

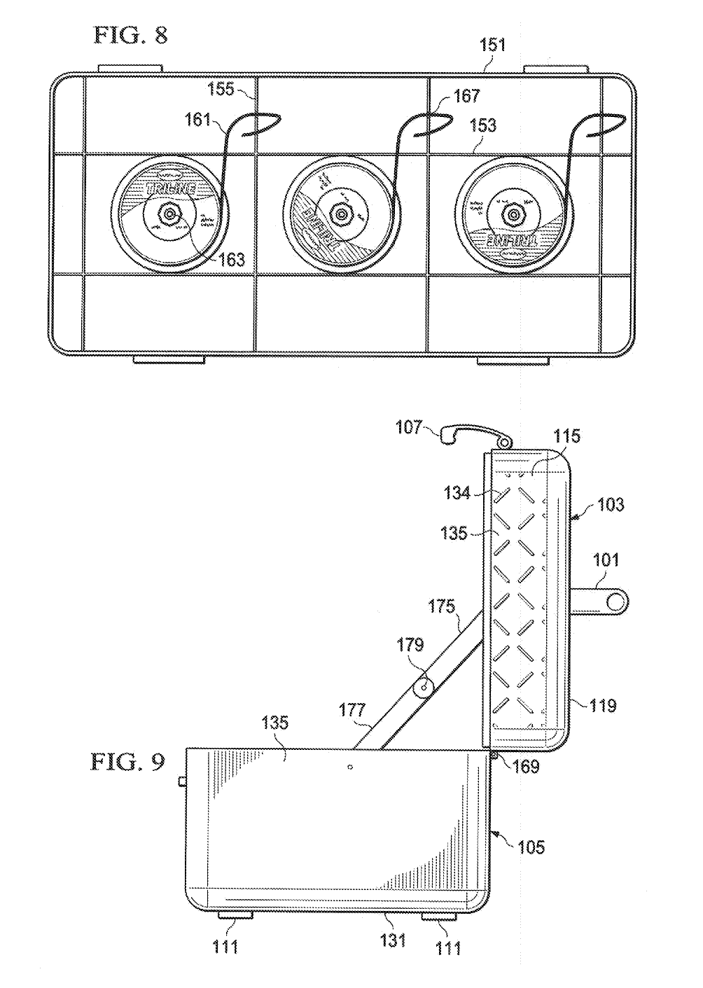

FIG. 9 illustrates a side view of the toolbox 100 in an open position and illustrates the top section 103 which has been rotated on hinges 169 with respect to the bottom section 105. FIG. 9 illustrates that the side top section surface 135 may include raised diamond shaped projections 134 in order to protect the surface, and the top surface 119 may be connected to a rotatable handle 101 to carry the toolbox 100. FIG. 9 additionally illustrates the side bottom section surface 133 which may be connected to the bottom surface 131 which may be connected to feet 111. The front top section surface 115 may be connected to a fastening device 107 to fasten the front top section surface 115 to the bottom section 105. The top section 103 may be connected to a top arm 175, and the bottom section 105 may be connected to a bottom arm 177. The top arm 175 and the bottom arm 177 may rotate and hold the top section 103 in an open position and may be connected to a shaft 179 so that the top section 103 and the bottom section 105 may open and close by pivoting on hinge 169.

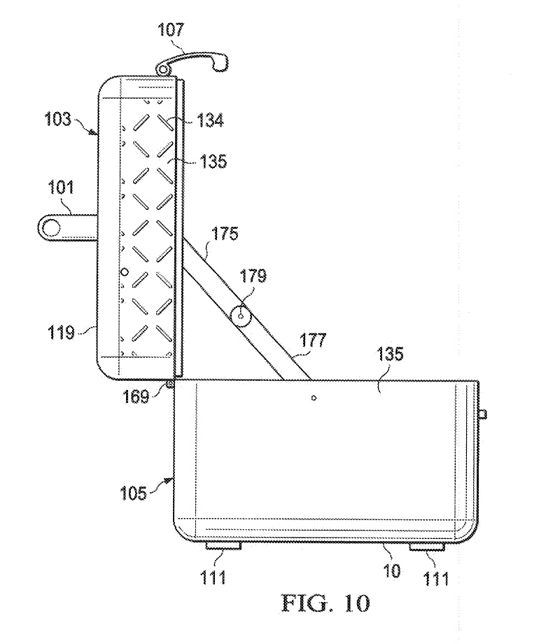

FIG. 10 illustrates an opposing side view of the toolbox 100 in an open position and illustrates the top section 103 which has been rotated on hinges 169 with respect to the bottom section 105. FIG. 10 illustrates that the opposing side top section surface 135 may include raised diamond shaped projections 134 in order to protect the surface, and the top surface 119 may be connected to a rotatable handle 101 to carry the toolbox 100. FIG. 10 additionally illustrates the side bottom section surface 133 which may be connected to the bottom surface 131 which may be connected to feet 111. The front top section surface 115 may be connected to a fastening device 107 to fasten the front top section surface 115 to the bottom section 105. The top section 103 may be connected to a top arm 175, and the bottom section 105 may be connected to a bottom arm 177. The top arm 175 and the bottom arm 177 may rotate and may be connected to a shaft 179 so that the top section 103 and the bottom section 105 may open and close by pivoting on hinge 169.

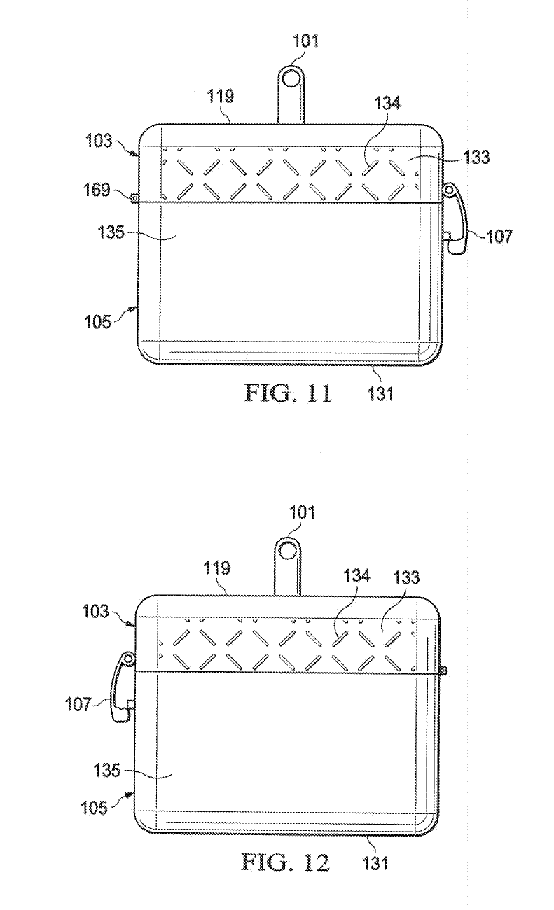

FIG. 11 illustrates a side view of the toolbox 100 which may correspond to FIG. 10 in a closed position and illustrates the top section 103 which has been rotated closed on hinges 169 with respect to the bottom section 105. FIG. 11 illustrates that the side top section surface 135 may include raised diamond shaped projections 134 in order to protect the surface, and the top surface 119 may be connected to a rotatable handle 101 to carry the toolbox 100. FIG. 11 additionally illustrates the side bottom section surface 133 which may be connected to the bottom surface 131 which may be connected to feet 111. The front top section surface 115 may be connected to a fastening device 107 to fasten the front top section surface 115 to the bottom section 105.

FIG. 12 illustrates a side view of the toolbox 100 which may correspond to FIG. 11 in a closed position and illustrates the top section 103 which has been rotated closed on hinges 169 with respect to the bottom section 105. FIG. 12 illustrates that the side top section surface 135 may include raised diamond shaped projections 134 in order to protect the surface, and the top surface 119 may be connected to a rotatable handle 101 to carry the toolbox 100. FIG. 12 additionally illustrates the side bottom section surface 133 which may be connected to the bottom surface 131 which may be connected to feet 111. The front top section surface 115 may be connected to a fastening device 107 to fasten the front top section surface 115 to the bottom section 105.

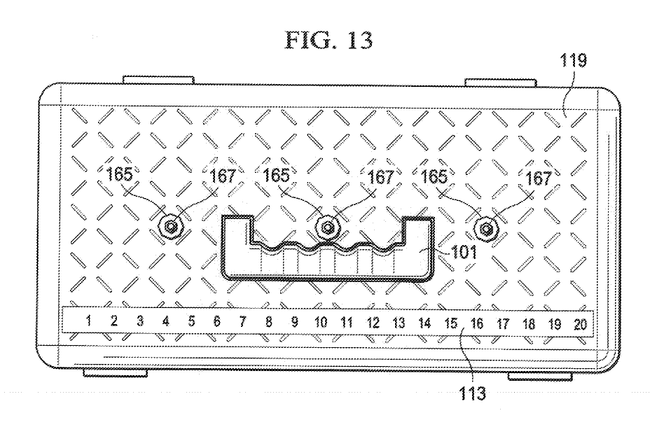

FIG. 13 illustrates a top view of the tackle box 100 of the present invention and illustrates the handle 101 which may be positioned on the top surface 119 and which may be rotatable. FIG. 13 may illustrate the shaft 167 and the fastening device 165 for the spool 159 of fishing line 161. Alternatively, the fastening device 165 and the shaft 167 may not extend to the top surface 119, but may be fastened to the bottom part of the lid.

FIG. 13 illustrates that the top surface 119 may include ruler indicia 113.

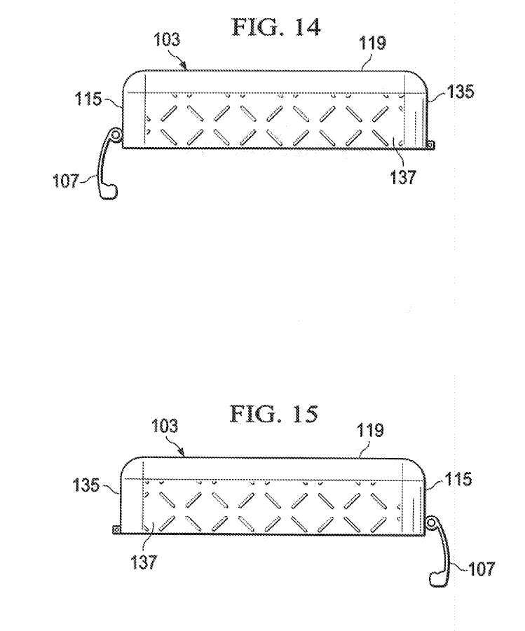

FIG. 14 illustrates the side top section surface 137 which may be connected to the top surface 119 and illustrates the front top section surface 115 connected to the side top section surface 137 and the top surface 119. The back top section surface 135 may be connected to the top surface 119 and the side top section surface 137.

FIG. 15 illustrates the opposing side top section surface 137 which may be connected to the top surface 119 and illustrates the front top section surface 115 connected to the side top section surface 137 and the top surface 119. The back top section surface 135 may be connected to the top surface 119 and the side top section surface 137.

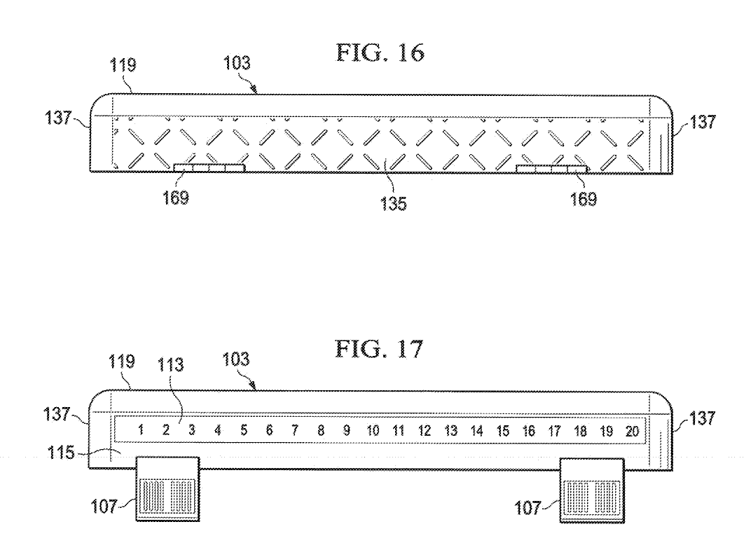

FIG. 16 illustrates a back view of the top section 103 and illustrates the back top section surface 135 which is connected to the side top section surface 137 and the top surface 119. FIG. 16 additionally illustrates hinges 161 to rotate the top section 103 with respect to the bottom section 105.

FIG. 17 illustrates a front view of the top section 103 and illustrates the front top section surface 115 which may include ruler indicia 113 and illustrates the fastening device 107. FIG. 17 illustrates the back top section surface 135 which is connected to the side top section surface 137 and the top surface 119.

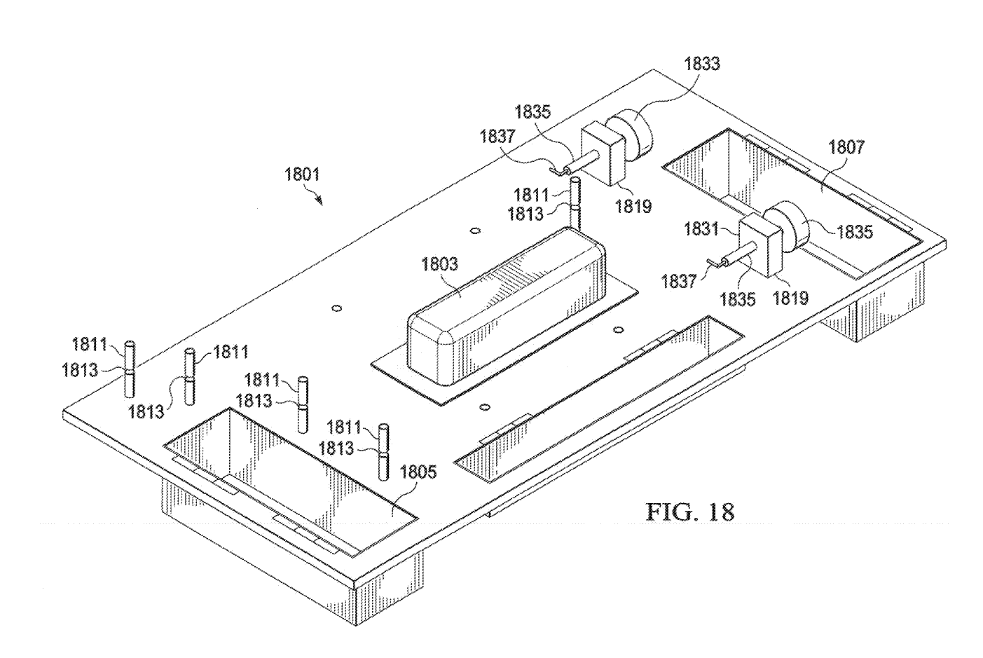

FIG. 18 illustrates a removable tray 1801 which is adapted to be positioned within the bottom section 105 of the tackle box 100. The removable tray 1801 may include an upward extending handle 1803 so the user can lift and remove the removable tray 1801 and replace the removable tray 1801 within the bottom section 105. The removable tray 1801 may include a first compartment 1805 and a second compartment 180 and a third compartment the 1809 which may be defined by substantially vertical walls.

The removable tray 1801 may include upward extending rods 1811 (as mounting post) which may include a radial grooves 1813 in order to provide a mount for a fishing swivel 1815 or a fishing line or fishing lure 1817 (not shown in FIG. 18); the radial grooves help prevent the slippage of the fishing swivel 1815 or the fishing line or fishing lower 1817. The upward extending rods 118 may be positioned at convenient locations and extend upwards from the floor of the removable tray 1801.

FIG. 18 additionally illustrates a tensioning device 1819 to tension fishing line or fishing lure and may include a base member 1831 which may include an aperture to accept a threaded shaft 1835 which may include a knob 1833 at a first end of the shaft 1835 and a finger 1837 at a second end of the shaft 1835 which may be traverse to the axial direction of the shaft 1835. Rotating the knob 1833 rotates the threaded shaft 1835 and either tightens the fishing line or fishing lure 1817. The finger 1837 acts to restrain the fishing line or fishing lower 1817 on the threaded shaft 1835. Rotating the knob and 1833 any opposing direction loosens the fishing line or fishing lure 1817. Multiple tensioning devices may be positioned on the removable tray 1801.

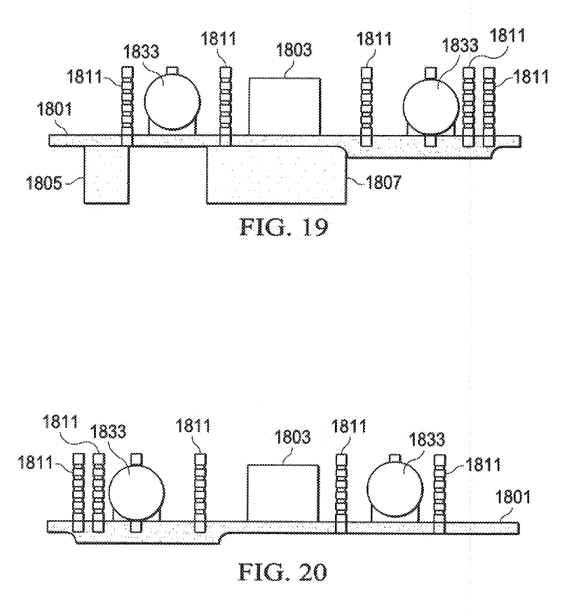

FIG. 19 illustrates an end view of the removable tray 1801 and illustrates the first compartment 1805, the second compartment 1807, and the upward extending handle 1803 which may be substantially centrally located on the removable tray 1801, the upward extending rods 1811, and the tensioning device 1819 including the knob 1833.

FIG. 20 illustrates an opposing end view of the removable tray 1801 and illustrates the first compartment 1805, the second compartment 1807, the upward extending handle 1803 which may be substantially centrally located on the removable tray 1801, the upward extending rods 1811, and the tensioning device 1819 including the knob 1833.

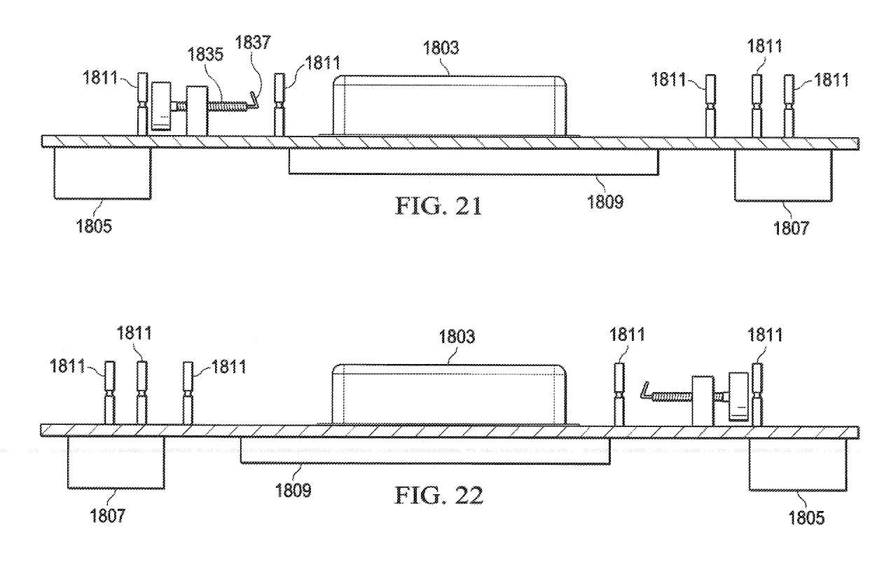

FIG. 21 illustrates a front view of the removable tray 1801 and illustrates the first compartment 1805, the second compartment 1807, the third compartment 1809, the upward extending handle 1803 which may be substantially centrally located on the removable tray 1801, the upward extending rods 1811, and the tensioning device 1819 including the knob 1833, the base 1831, the shaft 1835 and the finger 1837.

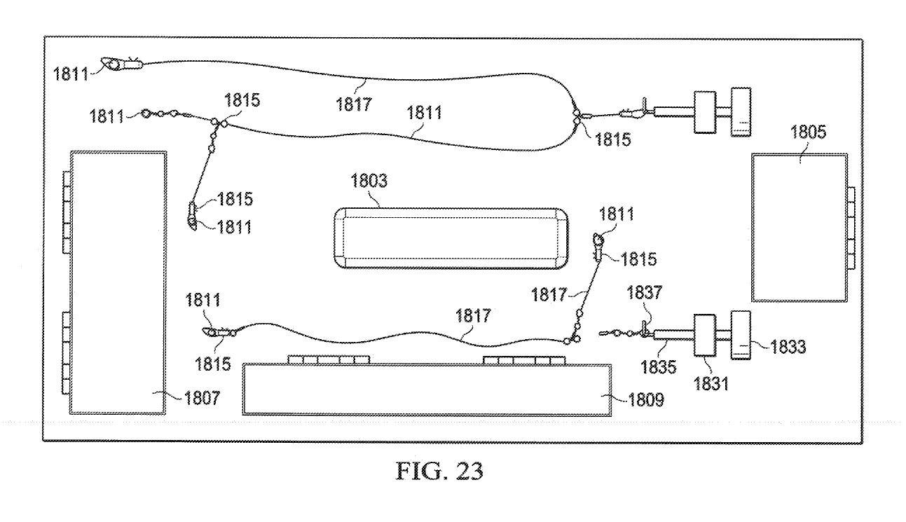

FIG. 23 illustrates a top view of the removable tray 1801 and illustrates the first compartment 1805, the second compartment 1807, the third compartment 1809, the upward extending handle 1803 which may be substantially centrally located on the removable tray 1801, the upward extending rods 1811, and the tensioning device 1819 including the knob 1833, the base 1831, the shaft 1835 and the finger 1837. The finger 187 may include a J shaped (or L-shaped) hook with a ball swivel The first compartment 1805, the second compartment 1807 and the third compartment 1809 may include a lid. FIG. 23 illustrates that the fishing swivel 1815 may be connected to the upward extending rods 1811 and may be connected to finger 1837 of the tensioning device 1819. The fishing swivel 1815 may be connected to fish line or fishing lure 1817. The consequent of the tightening device 1819 by turning the knob 1833, the fish line or fishing lure 1817 may be tightened for storage, and then the fishing line or fishing lure 1817 may be released for use by the user again by turning the knob 1833 of the tensioning device 1819.

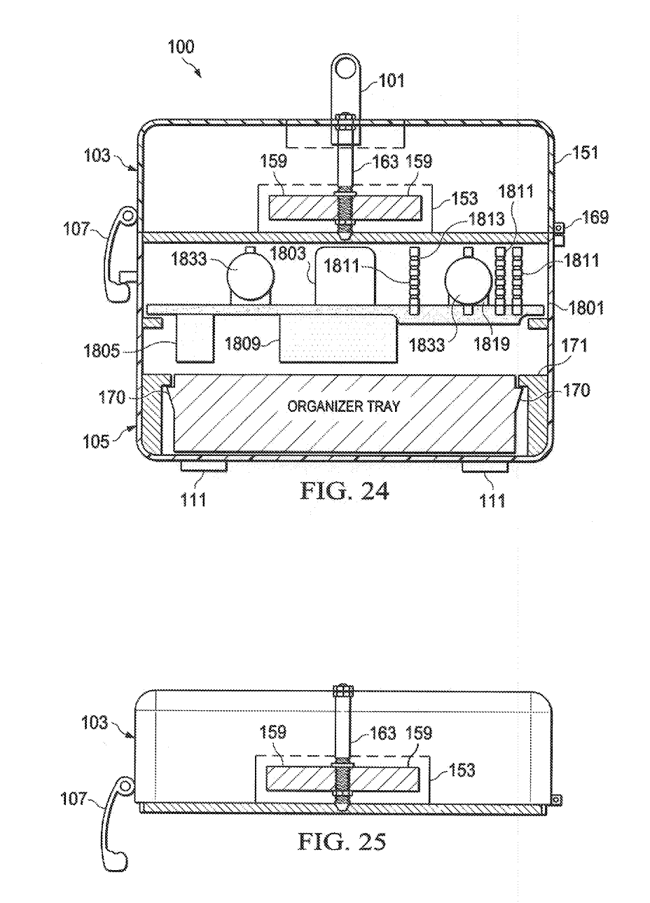

FIG. 24 illustrates a cross-sectional view of the tackle box 100 and illustrates the top section 103 and the bottom section 105. The top section 103 may include a rotatable handle 101, a fastening device 107 to fasten the top section 103 to the bottom section 105, the tray 151 which may include a tray compartments 153 and may include a spool 159 which may be mounted on a shaft 163. The top section 103 and the bottom section 104 may pivot on the hinge 169.

FIG. 24 additionally illustrates the bottom section 105 which may include an organizer tray 171 which may be detachably connected to the bottom section by tabs 170 and may be positioned under the removable tray 1801 which may include the first compartment 1805, the third compartment 1809, the upward extending handle 1803, the upward extending rods 1811, the radial grooves 1813, the tensioning device 1819 and the knob 1833.

FIG. 25 illustrates a cross-sectional view of the tackle box 100 and illustrates the top section 103. The top section 103 may include a fastening device 107 to fasten the top section 103 to the bottom section 105, the tray 151 which may include a tray compartment 153 and may include a spool 159 which may be mounted on a shaft 163. The spool 159 may be removed after the fishing line has been exhausted and replaced with a new spool 159.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A tackle box for fishing supplies, comprising:
a top section;
a bottom section being pivotably connected to the top section;
a removable tray being removable from the bottom section;
wherein the removable tray includes a tensioning device to tension a fishing line.

2) A tackle box for fishing supplies as in claim 1, wherein the removable tray includes an upward extending rod to cooperate with the tensioning device.

3) A tackle box for fishing supplies as in claim 2, wherein the tensioning device includes a base and a threaded shaft which extends through an aperture of the base.

4) A tackle box for fishing supplies as in claim 3, wherein the tensioning device includes a knob for turning the threaded shaft.

5) A tackle box for fishing supplies as in claim 3, wherein the tensioning device includes a finger connected to the threaded shaft.

6) A tackle box for fishing supplies as in claim 5, wherein the finger is traverse to the axial direction of the threaded shaft.

7) A tackle box for fishing supplies as in claim 2, wherein the upward extending rod includes a radial groove.

8) A tackle box for fishing supplies as in claim 1, wherein the top section includes a removable tray.

9) A tackle box for fishing supplies as in claim 8, wherein the removable tray includes a spool to dispense the fishing line.

10) A tackle box for fishing supplies as in claim 9, wherein the spool rotates on a shaft.

11) A tackle box for fishing supplies as in claim 10, wherein the removable tray includes a compartment defined by compartment walls to contain the spool.

12) A tackle box for fishing supplies as in claim 11, wherein at least one compartment wall includes a slit to hold the fishing line.
